(19) United States
(12) Patent Application Publication
(10) Pub. No.: US 2016/0296071 A1
(43) Pub. Date: Oct. 13, 2016

(54) RICE WRAPPER AND WRAPPED RICE

(71) Applicant: Shuichi Fujimori, Suwa-shi (JP)

(72) Inventor: Shuichi FUJIMORI, Suwa-shi (JP)

(21) Appl. No.: 15/036,371

(22) PCT Filed: Nov. 28, 2014
(86) PCT No.: PCT/JP2014/081575

§ 371 Date: May 12, 2016

(30) Foreign Application Priority Data
Dec. 9, 2013 (JP) 2013-253943

(51) Int. Cl. A47J 43/00; B65D 65/10

(52) U.S. Cl. CPC A47J 43/00; A23L 7/1965; B65D 65/10; A23V 2002/00

(57) ABSTRACT

A rice wrapper which can securely implement separation. The rice wrapper includes an outer film formed into a rectangular shape and provided with a separable part formed into a band shape along the entire length in the longitudinal direction thereof. An inner film is aligned on the outer film in a state such that the end edge parts in the direction of width of the two films are overlapped and fixed to the outer film, by heat sealing parts, at proper places on the peripheral edge parts. A foodstuff sheet is inserted between the outer film and the inner film. A cutting part in the outer film is provided separately from the separable part on the outer film between the separable part and one long side of the outer film in the direction of width and along the one long side.

### TECHNICAL FIELD

The present invention relates to a rice wrapper for wrapping cone-shaped rice, e.g., sushi rice, and wrapped rice which is wrapped by the same.

### BACKGROUND TECHNOLOGY

The inventor of the present invention has developed wrapped rice.

Namely, the wrapped rice is wrapped by a rice wrapper comprising: an outer film being formed into a rectangular shape and provided with a separable part, which is formed into a band shape along the entire length in the longitudinal direction of the outer film and arranged parallel to a long side thereof; an inner film being constituted by two films, aligned on the outer film in a state such that end edge parts in a direction of width of the two films are overlapped, and fixed to the outer film at proper places on peripheral edge parts; a foodstuff sheet being inserted between the outer film and the inner film, one corner part between the one short side and the other long side of the rice wrapper is positioned on a middle part of the facing one long side, the one corner part is wound as an inner winding part, a part of the other short side of the rice wrapper is wound on the inner winding part as an outer winding part and fixed on the inner winding part, thereby the rice wrapper is formed into a deformed cone shape in which a middle part of the other long side is formed as an apex, and nearly cone-shaped rice is accommodated in the nearly cone shaped rice wrapper (see Patent Document 1).

### PRIOR ART DOCUMENT

### Patent Document

Patent Document 1: Japanese Laid-open Patent Application Publication No. 2011-24561

### SUMMARY OF THE INVENTION

### Problem to be Solved by the Invention

In the wrapped rice disclosed in Patent Document 1, the wrapped rice is hand-rolled sushi formed into a deformed cone shape; when one side part of the rice wrapper is separated from the other side part thereof by pulling the separable part, the separable part is pulled obliquely outward (upward) with respect to the other side part, so the outer film cannot be linearly cut along the separable part and is obliquely cut with respect to the long side, and the cutting line reaches a heat sealing part located on the one long side of the outer film and the inner film so there is a possibility that the films cannot be further separated therefrom.

The present invention has been invented to solve the above described problem, and an object of the present invention is to provide an improved rice wrapper and wrapped rice which is wrapped by the improved rice wrapper.

### Means for Solving the Problem

The rice wrapper of the present invention comprises: an outer film being formed into a rectangular shape and provided with a separable part, which is formed into a band shape along the entire length in the longitudinal direction of the outer film; an inner film being constituted by two films, aligned on the outer film in a state such that the end edge parts in the direction of width of the two films are overlapped, and fixed to the outer film by heat sealing parts at proper places on the peripheral edge parts; and a foodstuff sheet being inserted between the outer film and the inner film, one side part, which includes one separated part of the outer film separated by the separable part and the one film of the inner film connected to the one separated part, is separable from the other side part, which includes the other separated part of the outer film and the other film of the inner film connected to the other separated part, when the outer film is separated by the separable part, and the rice wrapper is characterized by a cutting part in the outer film being provided separately from the separable part on the outer film between the separable part and one long side of the outer film in the direction of width and along the one long side.

The wrapped rice is wrapped by a rice wrapper, the rice wrapper comprises: an outer film being formed into a rectangular shape and provided with a separable part, which is formed into a band shape along the entire length in the longitudinal direction of the outer film; an inner film being constituted by two films, aligned on the outer film in a state such that the end edge parts in the direction of width of the two films are overlapped, and fixed to the outer film by heat sealing parts at proper places on the peripheral edge parts; a foodstuff sheet being inserted between the outer film and the inner film, one side part, which includes one separated part of the outer film separated by the separable part and the one film of the inner film connected to the one separated part, being separable from the other side part, which includes the other separated part of the outer film and the other film of the inner film connected to the other separated part, when the outer film is separated by the separable part; and a cutting part in the outer film being provided separately from the separable part on the outer film between the separable part and one long side of the outer film in the direction of width and along the one long side, one corner part between the one short side and the other long side of the rice wrapper is positioned on a middle part of the one long side in which the cutting part is provided, the one corner part is wound as an inner winding part, and a part of the other short side of the rice wrapper is wound on the inner winding part as an outer winding part and fixed on the inner winding part, thereby the rice wrapper is formed into a deformed cone shape in which a middle part of the other long side is formed as an apex, and nearly cone-shaped rice is accommodated in the nearly cone shaped rice wrapper.

### Effect of the Invention

In the present invention, even if the outer film is not linearly cut along the separable part and is cut obliquely, the outer film is cut by the cutting part, which is provided separately from the separable part, so that a cutting line does not reach the heat sealing parts and suitable cutting can be performed.

### BRIEF DESCRIPTION OF THE DRAWINGS

FIG. 1 It is an explanation view of an embodiment of a rice wrapper.

FIG. 2 It is an explanation view of a separable part, which is constituted by one cutting tape having a prescribed width.

FIG. 3 It is an explanation view of the separable part, which is constituted by two cutting tapes.

FIG. 4 It is an explanation view of the separable part, which is constituted by two perforation lines.

FIG. 5 It is an explanation view of an outer film, which is composed of an oriented film, and the separable part, which is constituted by two cuts.

FIG. 6 It is an explanation view of wrapped rice.

FIG. 7 It is an explanation view showing a separation starting position and a separation terminating position when the wrapped rice is held by a hand.

FIGS. 8A and 8B are explanation views showing a state where an inner winding part is folded back.

FIGS. 9A and 9B are explanation views showing a state where an outer winding part is folded back from the state shown in FIGS. 8A and 8B.

FIG. 10 It is an explanation view of the wrapped rice to which a cover is attached.

FIG. 11 It is an explanation view of further embodiment of the wrapped rice to which the cover is attached.

### EMBODIMENTS OF THE INVENTION

Preferred embodiments of the present invention will now be described in detail with reference to the accompanying drawings.

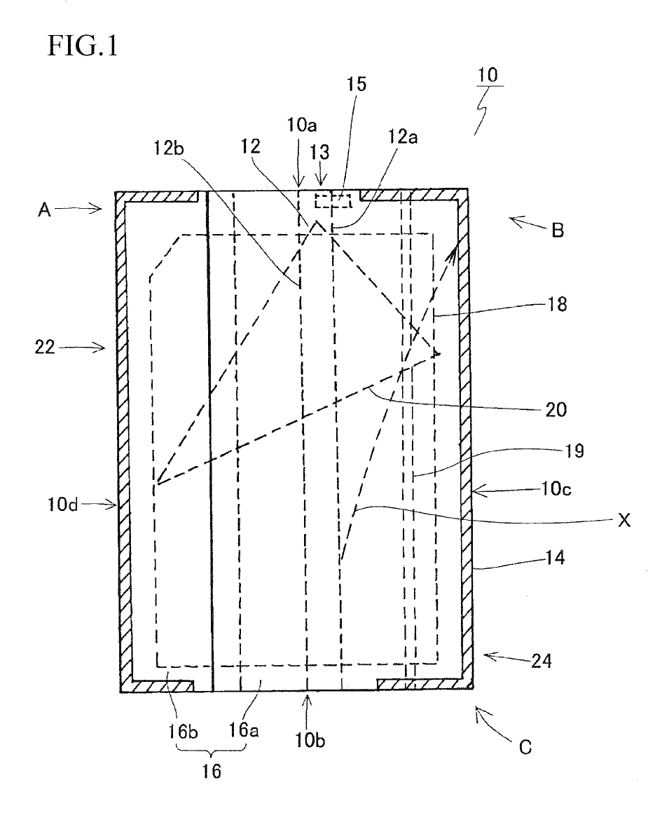

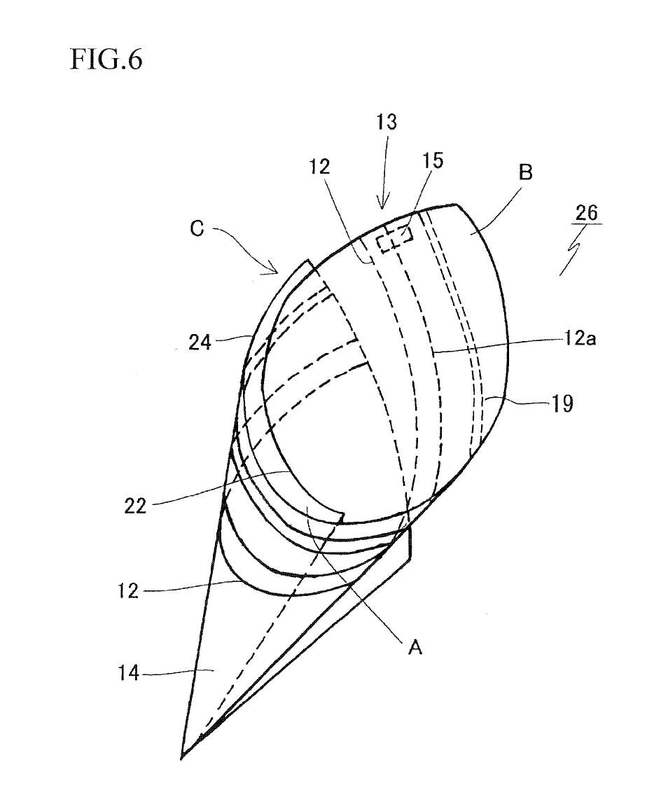

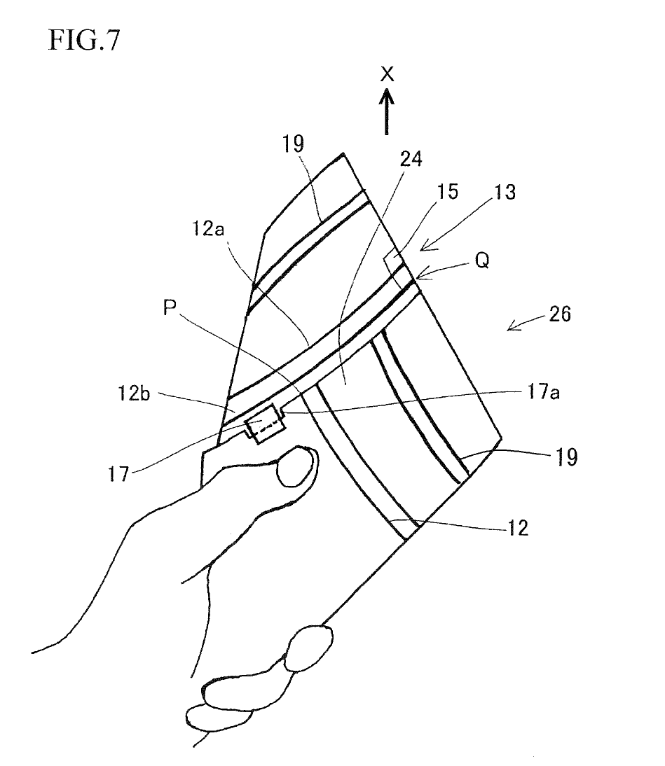

FIG. 1 is an explanation view of a rice wrapper (wrapper) 10 for wrapping rice, e.g., sushi rice, and FIGS. 6 and 7 are explanation views of rice (wrapped rice) 26.

The wrapper 10 comprises: an outer film 14 being formed into a rectangular shape and provided with a publicly-known separable part 12, which is formed into a band shape parallel to a long side and along the entire length in the longitudinal direction of the outer film; an inner film being constituted by two films 16a and 16b, aligned on the outer film 14 in a state such that the end edge parts in the direction of width of the films are overlapped, and fixed to the outer film 14 by heat sealing parts at proper places on peripheral edge parts; and a foodstuff sheet 18, e.g., seaweed sheet, being inserted between the outer film 14 and the inner films 16a and 16b. Note that, the term “rectangular shape” includes substantially rectangular shapes, e.g., nearly rectangular shape whose corner is obliquely cut.

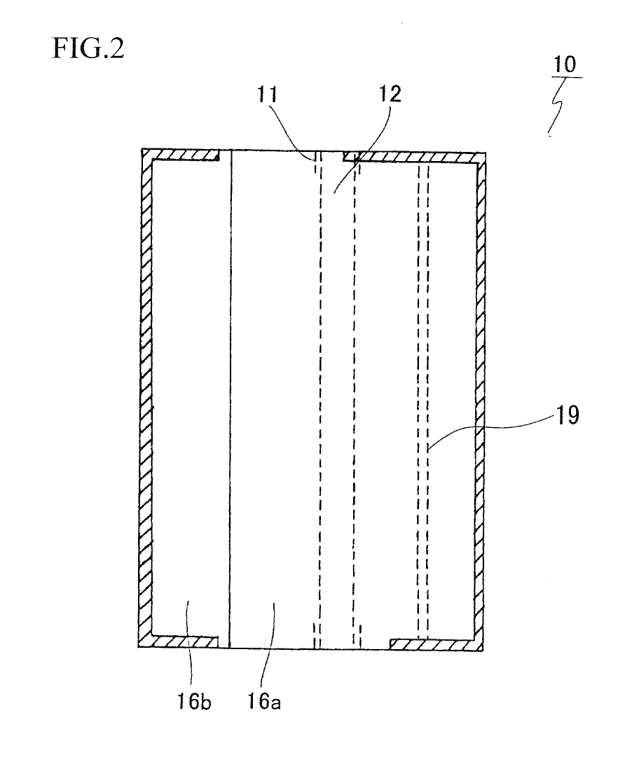

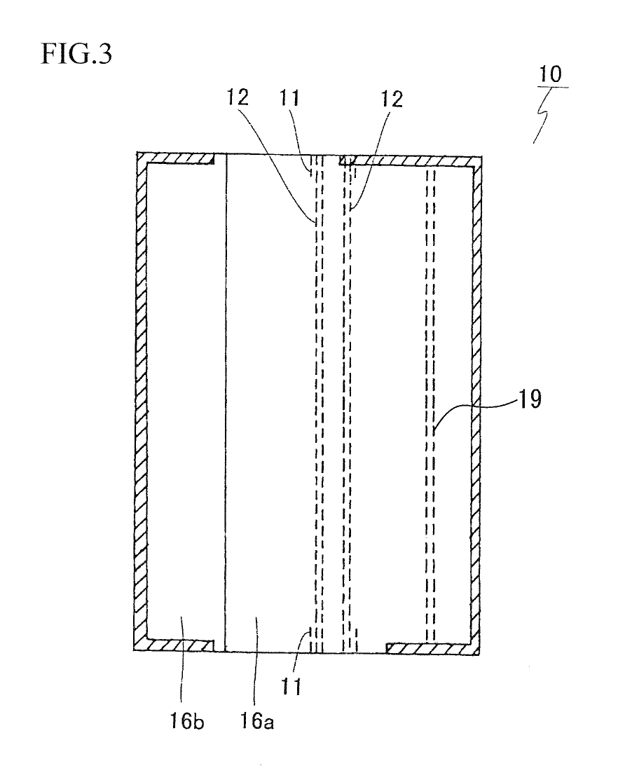

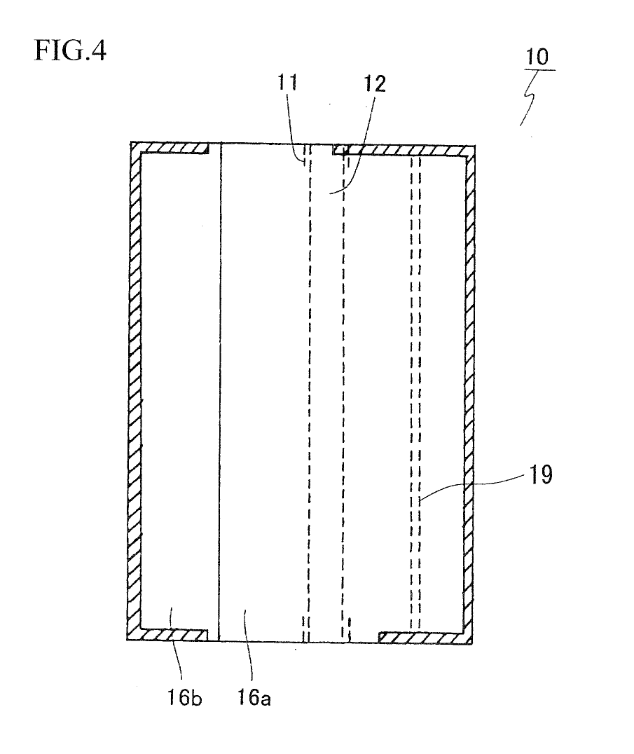

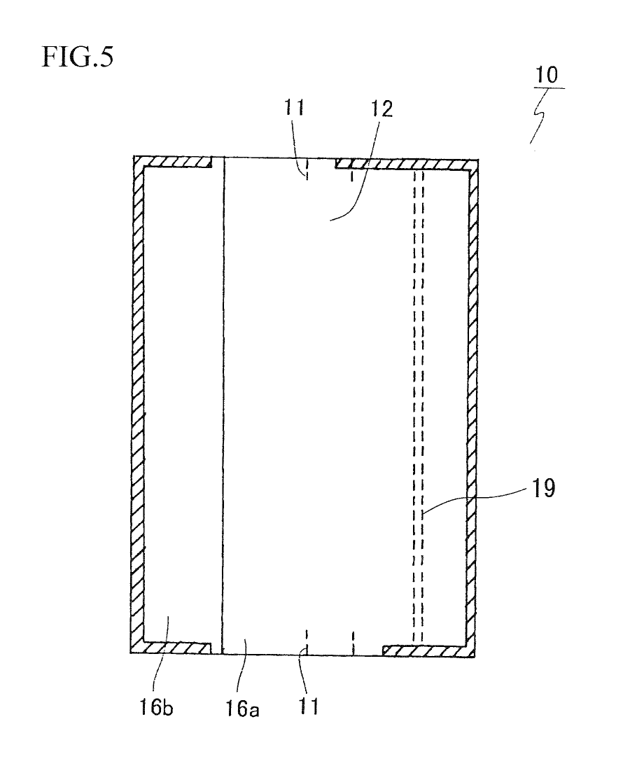

The separable part 12 may be constituted by one cutting tape having a prescribed width as shown in FIG. 2, two cutting tapes as shown in FIG. 3, two perforation lines shown in FIG. 4, etc. In any cases, cuts 11 are formed in the outer film 14 on both sides of end parts of the separable part 12, so that the outer film 14 can be easily cut. In FIG. 3, the two cutting tapes and a part of the outer film 14 between the cutting tapes are cut; in FIG. 4, a part of the outer film 14 between the two perforation lines are cut. In FIG. 5, the outer film 14 is composed of an oriented film, which can be easily cut in the longitudinal direction, and two cuts 11 are formed on one end side so as to cut (separate) the outer film along the cuts 11 as the separable part 12. Further, the outer film 14 may be divided into two in a width direction and partially heat-sealed although not shown.

The outer film 14 and the inner film 16 are mutually fixed by, for example, heat welding.

Positions of the heat welding parts (the hatched line parts shown in FIG. 1) are not limited, but they are formed such that one side part, which includes one separated part of the outer film 14 and the one film 16a connected to the one separated part, is separable from the other side part, which includes the other separated part of the outer film and the other film 16b connected to the other separated part, when the outer film 14 is separated into two by the separable part 12. Namely, the heat welding part of the one separated part of the outer film 14 and the film 16a is located on the opposite side of the heat welding part of the other separated part of the outer film 14 and the film 16b across the separable part 12.

In the present embodiment, the separable part 12 is partially connected to the one side part, so that the one side part can be separated from the other side part by one action of pulling the separable part 12.

Concretely, in the present embodiment, the band-shaped separable part 12 has an unseparable part 13, which is an end part of one widthwise peripheral edge part 12a (a longitudinal end part or an end part of a terminal end side in a cutting direction) of the separable part 12 and in which the outer film 14 cannot be separated into two. Note that, in case of using the two cutting tapes as shown in FIG. 3 or the two perforation lines as shown in FIG. 4, the one widthwise peripheral edge part 12a of the separable part 12 is one of the cutting tapes or one of the perforation lines; in case of using the oriented film as shown in FIG. 5, the one widthwise peripheral edge part is one of predetermined cutting lines which will be formed along the two cuts 11.

The other widthwise peripheral edge part 12b of the separable part 12 is capable of separating the outer film 14 into two along the entire length in the longitudinal direction thereof.

The unseparable part 13 may be formed by, for example, adhering the end of the one widthwise peripheral edge part 12a of the separable part 12 to the outer film 14 adjacent to the end by a fixing tape 15. Further, as shown in FIGS. 2-5, the unseparable part 13 may be formed by extending the heat sealing part, which mutually fixes the outer film 14 and the inner film 16, until reaching the end of the one widthwise peripheral edge part 12a of the separable part 12.

In the present embodiment, as shown in FIGS. 1-5, a cutting part 19, which is provided in a part of the outer film 14 connected to the end of the one peripheral edge part 12a of the band-shaped separable part 12 and which is located between the separable part 12 and the heat sealing part of the inner film 16a, is formed along the heat sealing part and separated from the separable part 12. For example, the cutting part 19 is formed by heat-welding a narrow cutting tape having a width of about 3 mm onto the outer film 14, so that the outer film 14 can be cut along the cutting tape. An end of the cutting tape reaches the heat welding part (heat sealing part) of the outer film 14 and the inner film 16a. Note that, the cutting part 19 need not be the cutting tape, so it may be, for example, a perforation line.

As described later, when rice, e.g., sushi rice, wrapped with the wrapper 10 is eaten, the separable part 12 is pulled in a direction X shown in FIG. 1 (a direction away from the other side part) so as to separate the one side part from the other side part, together with the separable part 12, by one action.

In case of pulling the separable part 12 in the direction X, the outer film is usually cut with the width of the separable part 12, and the one widthwise peripheral edge part 12a of the separable part 12 is not completely cut because of existing the unseparable part 13, but the other widthwise peripheral edge part 12b is completely cut, so that the one side part can be separated from the other side part, together with the separable part 12, by one action, as described above. Since the one side part is moved in the direction X and away from the other side part, the direction is, as shown in FIG. 1, an oblique direction (obliquely upward in FIG. 6) with respect to one long side 10c.

However, by pulling the separable part 12 in the direction X, the outer film 14 is sometimes obliquely cut, in the direction X shown in FIG. 1, from a middle part, and the cutting line reaches the sealing part of the one long side 10c of the outer film 14 and the inner film 16a, so the separable part cannot be pulled more and the other widthwise peripheral edge part 12b cannot be cut completely. Namely, in this case, the sushi rice cannot be taken out from the wrapper.

Thus, in the present embodiment, the cutting part 19, whose end reaches the heat sealing part and which is parallel to the separable part 12, is provided in a part of the outer film 14 between the one peripheral edge part 12a of the separable part 12 and the one long side 10c of the wrapper 10. By forming the cutting part 19, even if the outer film 14 is obliquely cut in the direction X shown in FIG. 1, the outer film is cut along the cutting part 19 when the cutting line reaches the cutting part 19, so that the other peripheral edge part 12b can be completely cut.

Even if the end of the cutting part 19 reaches the sealing part of the outer film 14 and the inner film 16a (on the longitudinal side), the sealing part is not cut as well as the unseparable part 13, so that the one side part can be separated from the other side part, together with the separable part 12, by one action.

Next, a manner for wrapping rice 20 (e.g., sushi rice) with the wrapper 10 and forming the wrapped rice 26 (see FIG. 6) like hand-rolled sushi is same as that disclosed in Patent Document 1, but the manner will be explained.

Firstly, the cone-shaped sushi rice 20 is obliquely disposed on the inner film 16 of the wrapper 10, at angle of about 45 degrees, in a state where an apex part of the sushi rice corresponds to a middle part of the other long side 10d of the wrapper 10 (a bottom part of the sushi rice faces a corner B).

Next, a triangular part of the wrapper 10, whose apex is a corner A between the other long side 10d and one short side 10a, is wound on the sushi rice 20 and along the outer shape thereof so as to form an inner winding part 22 (see FIG. 6).

Next, a part of the wrapper 10 on the other short side 10b side, which has a prescribed width, is wound on the inner winding part 22 so as to form an outer winding part 24 (see FIG. 6).

Then, the outer winding part 24 is fixed on the inner winding part 22 by a sealing tape 17 (see FIG. 7), heat sealing, etc., so that the wrapped rice 26 is produced. Note that, the sushi rice 20 is not shown in FIG. 6.

In this case, as shown in FIG. 6, the separable part 12 of the part of the outer film 14, which acts as the inner winding part 22, is not covered with the outer winding part 24, so it is suitable to expose the separable part 12 along the entire length of the outer film 14.

In case that the separable part 12 of the outer film 14 is not covered with the outer winding part 24 and is exposed along the entire length of the outer film 14, the outer film can be easily cut without interfering the separable part 12 by the outer winding part 24 when the separable part 12 cuts the outer film 14, so that the outer film can be removed, together with the inner film 16 previously separated, from the sushi rice 20, leaving the foodstuff sheet 18 on the sushi rice 20.

FIG. 7 shows a separation starting position P of the separable part 12 and a separation terminating position Q of the separable part 12 when the wrapped rice 26 is held by a hand, the separable part 12 is exposed along the entire length of the outer film 14, so it can be understood that the wrapped rice 26 can be easily held and that the outer film 14 can be easily removed by the separable part 12. Note that, in case that the sealing tape 17 reaches (covers) the separable part 12 when the outer winding part 24 is fixed on the inner winding part 22 by the sealing tape, it is suitable that a cut (small cut 17a) is formed in a peripheral edge part of the outer winding part 24, to which the sealing tape will be applied as shown in FIG. 7, so as to partially shift the peripheral edge part, so that the separable part 12 is covered with no sealing tape 17. Note that, a fixing position, at which the outer winding part 24 is fixed on the inner winding part 22 by the sealing tape 17, heat sealing, etc., is located on a wrapped rice 26 apex side (on the lower side) with respect to the position of the separable part 12, as shown in FIG. 7, so as not to fix the separated outer films to each other by the sealing tape 17, heat sealing, etc.

In the present embodiment, as described above, the unseparable part 13, at which the outer film 14 cannot be separated into two, is provided to the end of the one widthwise peripheral edge part 12a (the end of the terminal end side in the cutting direction) of the separable part 12.

Therefore, when the separable part 12 is pulled from the separation starting position P to the separation terminating position Q, the outer film 14 is not separated at the unseparable part 13 in the one peripheral edge part 12a, but the outer film 14 is separated into two in the other peripheral edge part 12b.

As described above, the outer film 14 is separated into two, along the entire length, by the other widthwise peripheral edge part 12b of the separable part 12, but the separable part 12 is connected to the one separated part of the outer film 14 (the upper separated film part) at the unseparable part 13. Therefore, as described above, the one side part of the wrapper, which includes the one separated part of the outer film connected to the separable part 12 and the one inner film (the upper film) 16a previously connected to the one separated part of the outer film, can be separated (peeled) upward from the other side part, which includes the other separated part of the outer film and the other inner film 16b previously connected to the other separated part, by only pulling the separable part 12 (leaving the foodstuff sheet 18 on the sushi rice 20).

A manner for wrapping the rice (sushi rice) with this wrapper 10 will be explained. Note that, to facilitate understanding, the rice (sushi rice) 20 is not shown.

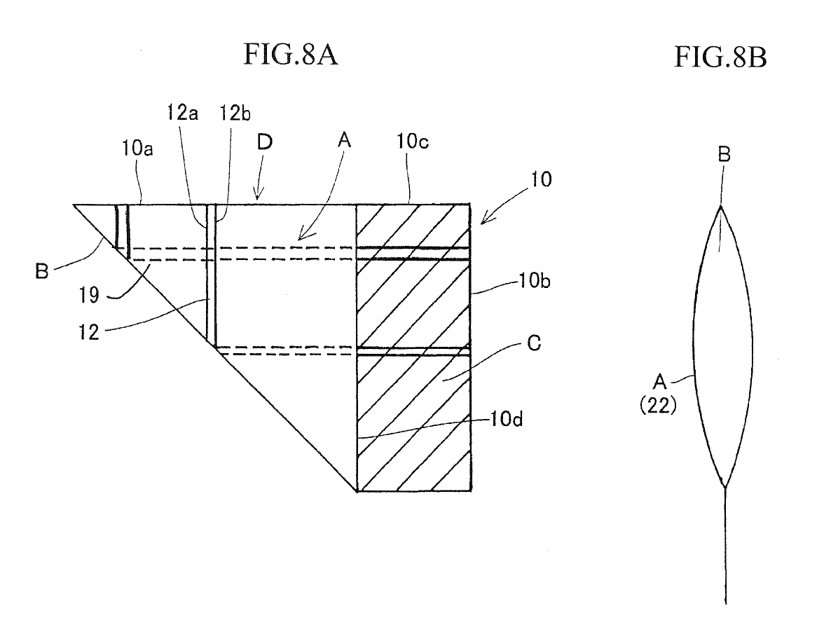

In FIG. 8A, a triangular part of the wrapper 10, which includes the corner A of the one short side 10a, is folded back (actually, formed into an arc shape along the outer circumference of the sushi rice). Namely, the part including the corner A is folded back, such that the long side 10d on the corner A side (the other long side) is arranged perpendicular to the long side 10c on the corner B side (the one long side). In this state, the sushi rice is wrapped inside, actually the short side 10a and the long side 10c are not overlapped, but they look like they are overlapped when seen from the direction of FIG. 8A, so that appearance of the wrapped rice can be improved. Note that, FIG. 8B is a view seen from a direction D indicated in FIG. 8A.

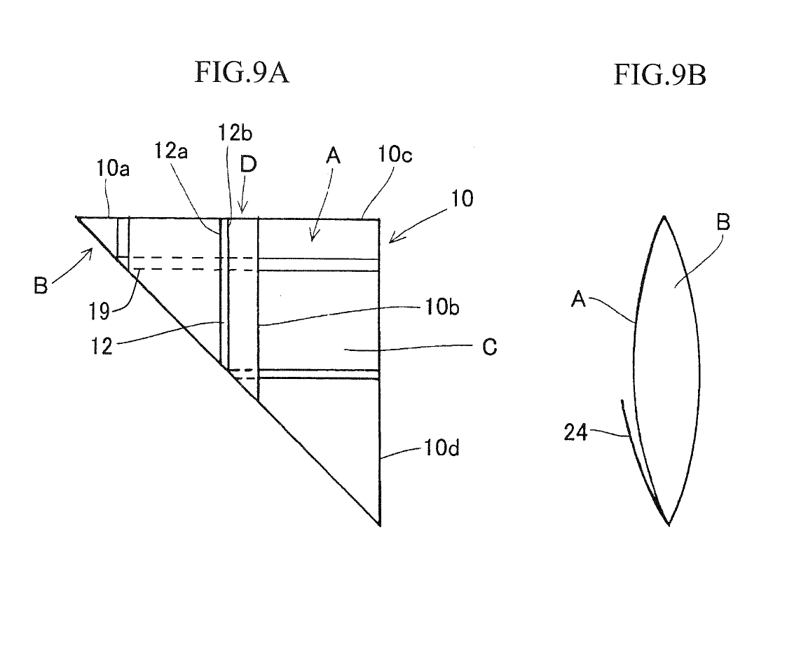

Next, as shown in FIG. 9A, a part of the wrapper 10 (the hatched line part shown in FIG. 8A), which has a prescribed width and is located on the other short side 10b side, is folded along the long side 10d in the above described folded part as a folding line (actually, formed into an arc shape along the outer circumference of the sushi rice) to form the outer winding part 24. The part covered with the outer winding part 24 is the inner winding part 22. In this case, the long side 10c and the one short side 10a of the wrapper 10 are mutually overlapped (see FIG. 9A), so that appearance of the wrapped rice can be improved.

By fixing the outer winding part 24 to the inner winding part 22 with the sealing tape (not shown), heat sealing, etc., the wrapped rice 26 is completed. Note that, a suitable foodstuff (not shown) is mounted onto an exposed part of the sushi rice. FIG. 9B is a view seen from a direction D indicated in FIG. 9A.

Further, in the above described embodiment, as shown in FIG. 1, it is suitable to employ the wide film 16a and the narrow film 16b, which is narrower than the wide film 16a, as the inner film 16 constituted by the two films. In this case, the narrow film 16b is disposed close to the long side 10d of the wrapper 10, so that the separated films can be suitably easily pulled out as described later. Note that, as to the overlapping part of the inner films 16a and 16b, either of the films may be disposed on the outer side or inner side. One or both of the films in the overlapping part may be further two-folded (not shown).

Further, a corner of the foodstuff sheet 18 on the corner A side may be obliquely cut as shown in FIG. 1. In this case, the film will not be caught by the corner of the foodstuff sheet 18 and can be easily pulled out as described later.

As described above, since the inner film 16 is constituted by the wide film 16a and the narrow film 16b, an upper part of the outer film 14 (including the corner B) and the wide film 16a of the inner film 16 fixed to the upper part can be easily pulled out upward, leaving the foodstuff sheet 18 on the sushi rice 20, when the outer film 14 is separated into two by the separable part 12. The film 16a of the inner film 16 is wide, so resistance between the film and the sushi rice 20 is increased and the films cannot be easily pulled out, but the film are upwardly pulled toward an opened space above the sushi rice 20, so that the films can be easily pulled out without being interfered by the foodstuff sheet 18 even if the foodstuff sheet 18 exists.

Maybe it is uneasy to pull a lower part of the separated outer film 14 and the narrow film 16b of the inner film 16 fixed to the lower part downward due to the foodstuff sheet 18 which narrows toward a lower end, but they can be easily peeled from the foodstuff sheet 18 and the sushi rice 20 and can be easily pulled out because of employing the narrow film 16b of the inner film 16.

Especially, in case that a part of the narrow film 16b, which is located close to the corner A and on the short side 10a side, is not heat-sealed to the outer film 14 and/or the foodstuff sheet 18 is obliquely cut, the separated films can be more easily pulled out downward.

To more easily pull out the separated films, edible oil may be mixed with the sushi rice. The edible oil may be applied on inner surfaces of the inner film 16. Further, edible powder may be attached on a surface of the rice, e.g., sushi rice, so as to restrain stickiness of the sushi rice, so that the separated films can be smoothly and easily pulled out.

In the above described embodiment, the wrapped rice 26 is produced by winding the wrapper 10 onto the cone-shaped sushi rice 20 for easy understanding. Actually, in case of producing the wrapped rice 26, it is suitable to previously form the wrapper 10 into a deformed cone shape as shown in FIG. 6 and drop the cone-shaped sushi rice 20 into the deformed cone-shaped wrapper 10. With this manner, the sushi rice can be automatically wrapped by continuously conveying the deformed cone-shaped wrappers 10, which have been previously formed, into a production apparatus (not shown) and dropping the cone-shaped sushi rice 20, which has been previously formed, into the wrappers one by one.

The wrapper 10 (see FIG. 2) previously formed into the deformed cone shape will be explained.

The corner A between the one short side 10a and the other long side 10d of the wrapper 10 is positioned to the middle part (on the middle part) of the one long side 10c, the part including the corner A is wound as the inner winding part 22, then the part of the wrapper 10 on the short side 10b side is wound on the inner winding part 22, as the outer winding part 24, and fixed on the inner winding part 22, so that the wrapper, which is formed into the deformed cone shape and in which the middle part of the other long side 10d becomes the apex (see FIG. 6).

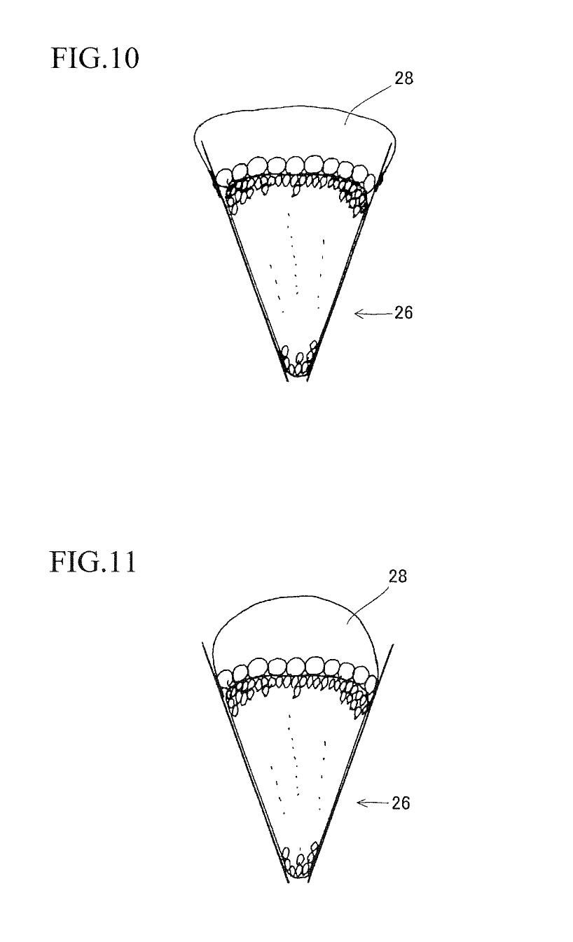

FIGS. 10 and 11 show further embodiments, in each of which the wrapped rice 26 is covered with a cover (cap) 28 so as to cover the exposed part (a bottom part of the cone shape) of the sushi rice 20.

In FIG. 10, the cover 28 is provided outside of the wrapped rice 26, and the cover 28 may be fixed to the wrapped rice 26 by a fixing tape (not shown), etc. Preferably, the cover 28 can be simultaneously detached when separating the outer film 14 by the separable part 12.

In FIG. 11, an end fringe part of the cover 28 is inserted in an upper part of the wrapped rice 26 (between the sushi rice and the wrapper) so as to cover the wrapped rice 26.

Note that, in the above described embodiments, the unseparable part 13 is formed by extending the sealing tape 15 or the heat sealing part, and fixing the one widthwise peripheral edge part 12a of the separable part 12 to the outer film 14, but the unseparable part 13 need not be formed. In case of forming no unseparable part 13 too, if the wrapped rice is formed into the deformed cone shape like hand-rolled sushi, the separable part is pulled in the direction X. Therefore, in this case too, by forming the cutting part 19, even if the cutting direction is deviated in the direction X shown in FIG. 1, the cutting direction can be corrected by the cutting part 19, so that the films can be securely cut.

1-9. (canceled)

10. A rice wrapper comprising: an outer film being formed into a rectangular shape and provided with a separable part, which is formed into a band shape along the entire length in the longitudinal direction of the outer film; an inner film being constituted by two films, aligned on the outer film in a state such that the end edge parts in the direction of width of the two films are overlapped, and fixed to the outer film by heat sealing parts at proper places on the peripheral edge parts; and a foodstuff sheet being inserted between the outer film and the inner film, wherein one side part, which includes one separated part of the outer film separated by the separable part and the one film of the inner film connected to the one separated part, is separable from the other side part, which includes the other separated part of the outer film and the other film of the inner film connected to the other separated part, when the outer film is separated by the separable part,
said rice wrapper being characterized by a cutting part in the outer film being provided separately from the separable part on the outer film between the separable part and one long side of the outer film in the direction of width and along the one long side.

11. The rice wrapper according to claim 10, wherein the band-shaped separable part is connected to the one side part at an end part of the one peripheral edge part of the one long side, is unable to be separated from the one side part at the connected part, and is separable from the other side part on the other peripheral edge part, and
the one side part, which is connected to the end part of the one peripheral edge part of the band-shaped separable part, can be separated from the other side part, together with the separable part, by one action of pulling the separable part.

12. The rice wrapper according to claim 11, wherein the band-shaped separable part has a prescribed width, and the heat sealing part is extended until reaching the end part of the one peripheral edge part of the one long side so that the separable part is connected to the one separated part of the outer film at the end part and is unable to be separated from the one side part at the connected part.

13. The rice wrapper according to claim 10, wherein an end part of the cutting part is extended until reaching the heat sealing part of a short side.

14. The rice wrapper according to claim 11, wherein an end part of the cutting part is extended until reaching the heat sealing part of a short side.

15. The rice wrapper according to claim 12, wherein an end part of the cutting part is extended until reaching the heat sealing part of a short side.

16. The rice wrapper according to claim 10, wherein one corner part between the one short side and the other long side of the rice wrapper is positioned on a middle part of the one long side in which the cutting part is provided, the one corner part is wound as an inner winding part, and a part of the other short side of the rice wrapper is wound on the inner winding part as an outer winding part and fixed on the inner winding part, thereby the rice wrapper is formed into a deformed cone shape in which a middle part of the other long side is formed as an apex.

17. The rice wrapper according to claim 11, wherein one corner part between the one short side and the other long side of the rice wrapper is positioned on a middle part of the one long side in which the cutting part is provided, the one corner part is wound as an inner winding part, and a part of the other short side of the rice wrapper is wound on the inner winding part as an outer winding part and fixed on the inner winding part, thereby the rice wrapper is formed into a deformed cone shape in which a middle part of the other long side is formed as an apex.

18. The rice wrapper according to claim 12, wherein one corner part between the one short side and the other long side of the rice wrapper is positioned on a middle part of the one long side in which the cutting part is provided, the one corner part is wound as an inner winding part, and a part of the other short side of the rice wrapper is wound on the inner winding part as an outer winding part and fixed on the inner winding part, thereby the rice wrapper is formed into a deformed cone shape in which a middle part of the other long side is formed as an apex.

19. The rice wrapper according to claim 13, wherein one corner part between the one short side and the other long side of the rice wrapper is positioned on a middle part of the one long side in which the cutting part is provided, the one corner part is wound as an inner winding part, and a part of the other short side of the rice wrapper is wound on the inner winding part as an outer winding part and fixed on the inner winding part, thereby the rice wrapper is formed into a deformed cone shape in which a middle part of the other long side is formed as an apex.

20. The rice wrapper according to claim 14, wherein one corner part between the one short side and the other long side of the rice wrapper is positioned on a middle part of the one long side in which the cutting part is provided, the one corner part is wound as an inner winding part, and a part of the other short side of the rice wrapper is wound on the inner winding part as an outer winding part and fixed on the inner winding part, thereby the rice wrapper is formed into a deformed cone shape in which a middle part of the other long side is formed as an apex.

21. The rice wrapper according to claim 15, wherein one corner part between the one short side and the other long side of the rice wrapper is positioned on a middle part of the one long side in which the cutting part is provided, the one corner part is wound as an inner winding part, and a part of the other short side of the rice wrapper is wound on the inner winding part as an outer winding part and fixed on the inner winding part, thereby the rice wrapper is formed into a deformed cone shape in which a middle part of the other long side is formed as an apex.

22. Wrapped rice being wrapped by a rice wrapper, the rice wrapper comprising: an outer film being formed into a rectangular shape and provided with a separable part, which is formed into a band shape along the entire length in the longitudinal direction of the outer film; an inner film being constituted by two films, aligned on the outer film in a state such that the end edge parts in the direction of width of the two films are overlapped, and fixed to the outer film by heat sealing parts at proper places on the peripheral edge parts; a foodstuff sheet being inserted between the outer film and the inner film, wherein one side part, which includes one separated part of the outer film separated by the separable part and the one film of the inner film connected to the one separated part, is separable from the other side part, which includes the other separated part of the outer film and the other film of the inner film connected to the other separated part, when the outer film is separated by the separable part; and a cutting part in the outer film being provided separately from the separable part on the outer film between the separable part and one long side of the outer film in the direction of width and along the one long side,
wherein one corner part between the one short side and the other long side of the rice wrapper is positioned on a middle part of the one long side in which the cutting part is provided, the one corner part is wound as an inner winding part, and a part of the other short side of the rice wrapper is wound on the inner winding part as an outer winding part and fixed on the inner winding part, thereby the rice wrapper is formed into a deformed cone shape in which a middle part of the other long side is formed as an apex, and
nearly cone-shaped rice is accommodated in the nearly cone shaped rice wrapper.

23. The wrapped rice according to claim 22, wherein the band-shaped separable part is connected to the one side part at an end part of the one peripheral edge part of the one long side, is unable to be separated from the one side part at the connected part, and is separable from the other side part on the other peripheral edge part, and
the one side part, which is connected to the end part of the one peripheral edge part of the band-shaped separable part, can be separated from the other side part, together with the separable part, by one action of pulling the separable part.

24. The wrapped rice according to claim 23, wherein the band-shaped separable part has a prescribed width, and the heat sealing part is extended until reaching the end part of the one peripheral edge part of the one long side so that the separable part is connected to the one separated part of the outer film at the end part and is unable to be separated from the one side part at the connected part.

25. The wrapped rice according to claim 22, wherein an end part of the cutting part is extended until reaching the heat sealing part of a short side.

26. The wrapped rice according to claim 23, wherein an end part of the cutting part is extended until reaching the heat sealing part of a short side.

27. The wrapped rice according to claim 24, wherein an end part of the cutting part is extended until reaching the heat sealing part of a short side.
